(19) United States
(12) Patent Application Publication
(10) Pub. No.: US 2026/0004663 A1
(43) Pub. Date: Jan. 1, 2026

(54) SYSTEMS, APPARATUSES, METHODS, AND COMPUTER PROGRAM PRODUCTS FOR SEARCH EVENT OPERATIONS

(71) Applicant: Honeywell International Inc., Charlotte, NC (US)

(72) Inventors: Muthusankar Subramaniyan, Madurai (IN); Sivakumar Kanagarajan, Bangalore (IN); Gobinathan Baladhandapani, Madurai (IN); Srilakshmi Kurudi, Bangalore (IN); Karthikeyan M, Madurai (IN)

(21) Appl. No.: 18/925,686

(22) Filed: Oct. 24, 2024

(30) Foreign Application Priority Data
Jun. 28, 2024 (IN) 202411049620

(51) Int. Cl. G08G 5/00

(52) U.S. Cl. CPC G08G 5/34; G08G 5/26

(57) ABSTRACT

Systems, apparatuses, methods, and computer program products are provided herein. For example, a method includes receiving search event data representative of a search event. In some embodiments, the method includes accessing real-time target physical condition data from a target device. In some embodiments, the real-time target physical condition data is representative of one or more real-time target physical condition items. In some embodiments, the method includes generating a target physical condition interface component based on the real-time target physical condition data. In some embodiments, the method includes generating a search event access interface component. In some embodiments, the search event access interface component comprises one or more access links. In some embodiments, the method includes causing the target physical condition interface component to be rendered to a search event operations interface in response to a selection of a target physical condition access link of the one or more access links.

### CROSS REFERENCE TO RELATED APPLICATIONS

This application claims the benefit of India Provisional Patent Application No. 202411049620, filed Jun. 28, 2024, the entire contents of which are incorporated by reference herein.

### TECHNOLOGICAL FIELD

Embodiments of the present disclosure relate generally to systems, apparatuses, methods, and computer program products for search event operations.

### BACKGROUND

Applicant has identified many technical challenges and difficulties associated with systems, apparatuses, methods, and computer program products for search event operations. Through applied effort, ingenuity, and innovation, Applicant has solved problems related to systems, apparatuses, methods, and computer program products for search event operations by developing solutions embodied in the present disclosure, which are described in detail below.

### BRIEF SUMMARY

Various embodiments described herein relate to systems, apparatuses, methods, and computer program products for search event operations.

In accordance with one aspect of the disclosure, a method is provided. In some embodiments, the method may include receiving search event data representative of a search event. In some embodiments, the method includes accessing real-time target physical condition data from a target device. In some embodiments, the real-time target physical condition data is representative of one or more real-time target physical condition items. In some embodiments, the method includes generating a target physical condition interface component based on the real-time target physical condition data. In some embodiments, the target physical condition interface component comprises the one or more real-time target physical condition items. In some embodiments, the method includes generating a search event access interface component. In some embodiments, the search event access interface component comprises one or more access links. In some embodiments, the method includes causing the target physical condition interface component to be rendered to a search event operations interface in response to a selection of a target physical condition access link of the one or more access links.

In some embodiments, the target device comprises a wearable device.

In some embodiments, the method includes initiating performance of one or more search event responsive actions.

In some embodiments, initiating performance of one or more search event responsive actions comprises transmitting an action message to the target device.

In some embodiments, initiating performance of one or more search event responsive actions comprises transmitting an instruction message to an enterprise device.

In some embodiments, initiating performance of one or more search event responsive actions comprises detecting one or more secondary devices in proximity to the target device.

In some embodiments, initiating performance of one or more search event responsive actions comprises transmitting an alert message to the one or more secondary devices.

In some embodiments, initiating performance of one or more search event responsive actions comprises detecting a cellular tower in proximity to the target device.

In some embodiments, initiating performance of one or more search event responsive actions comprises causing an aircraft to navigate towards the cellular tower in response to detecting the cellular tower in proximity to the target device.

In some embodiments, the method includes generating a target proximity interface component.

In some embodiments, the target proximity interface component comprises one or more target proximity action items.

In some embodiments, the method includes generating a historical search event interface component.

In some embodiments, the historical search event interface component comprises one or more historical search event action items.

In some embodiments, the method includes generating a target device activity interface component.

In some embodiments, the target device activity interface component comprises one or more target device activity items.

In some embodiments, the method includes generating a search zone interface component.

In some embodiments, the search zone interface component comprises a horizontal view sub-interface component and a vertical view sub-interface component.

In some embodiments, the method includes causing the search zone interface component to be rendered to a search zone interface.

In some embodiments, the method includes accessing static target physical condition data representative of one or more static target physical condition items.

In some embodiments, the target physical condition interface component further comprises the one or more static target physical condition items.

In some embodiments, the real-time target physical condition data is accessed from the target device in response to receiving the search event data.

In accordance with another aspect of the disclosure, an apparatus is provided. In some embodiments, the apparatus comprises memory and one or more processors communicatively coupled to the memory. In some embodiments, the one or more processors are configured to receive search event data representative of a search event. In some embodiments, the one or more processors are configured to access real-time target physical condition data from a target device. In some embodiments, the real-time target physical condition data is representative of one or more real-time target physical condition items. In some embodiments, the one or more processors are configured to generate a target physical condition interface component based on the real-time target physical condition data. In some embodiments, the target physical condition interface component comprises the one or more real-time target physical condition items. In some embodiments, the one or more processors are configured to generate a search event access interface component. In some embodiments, the search event access interface component comprises one or more access links. In some embodiments, the one or more processors are configured to cause the target physical condition interface component to be rendered to a search event operations interface in response to a selection of a target physical condition access link of the one or more access links.

In some embodiments, the one or more processors are further configured to initiate performance of one or more search event responsive actions.

In some embodiments, initiating performance of one or more search event responsive actions comprises the one or more processors being further configured to transmit an action message to the target device.

In some embodiments, initiating performance of one or more search event responsive actions comprises the one or more processors being further configured to transmit an instruction message to an enterprise device.

In some embodiments, initiating performance of one or more search event responsive actions comprises the one or more processors being further configured to detect one or more secondary devices in proximity to the target device.

In some embodiments, initiating performance of one or more search event responsive actions comprises the one or more processors being further configured to transmit an alert message to the one or more secondary devices.

In some embodiments, initiating performance of one or more search event responsive actions comprises the one or more processors being further configured to detect a cellular tower in proximity to the target device.

In some embodiments, initiating performance of one or more search event responsive actions comprises the one or more processors being further configured to cause an aircraft to navigate towards the cellular tower in response to detecting the cellular tower in proximity to the target device.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for receiving search event data representative of a search event. In some embodiments, the computer program code, in execution with at least one processor, configures the computer program product for accessing real-time target physical condition data from a target device. In some embodiments, the real-time target physical condition data is representative of one or more real-time target physical condition items. In some embodiments, the computer program code, in execution with at least one processor, configures the computer program product for generating a target physical condition interface component based on the real-time target physical condition data. In some embodiments, the target physical condition interface component comprises the one or more real-time target physical condition items. In some embodiments, the computer program code, in execution with at least one processor, configures the computer program product for generating a search event access interface component. In some embodiments, the search event access interface component comprises one or more access links. In some embodiments, the computer program code, in execution with at least one processor, configures the computer program product for causing the target physical condition interface component to be rendered to a search event operations interface in response to a selection of a target physical condition access link of the one or more access links.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example block diagram of an environment in which embodiments of the present disclosure may operate;

FIG. 2 illustrates an example block diagram of an example apparatus that may be specially configured in accordance with an example embodiment of the present disclosure;

FIG. 3 illustrates an interface component in accordance with one or more embodiments of the present disclosure;

FIG. 4 illustrates an interface component in accordance with one or more embodiments of the present disclosure;

FIG. 5 illustrates an interface component in accordance with one or more embodiments of the present disclosure;

FIG. 6 illustrates an interface component in accordance with one or more embodiments of the present disclosure;

FIG. 7 illustrates an interface component in accordance with one or more embodiments of the present disclosure;

FIG. 8 illustrates an interface component in accordance with one or more embodiments of the present disclosure;

FIG. 9 illustrates an interface component in accordance with one or more embodiments of the present disclosure;

FIG. 10 illustrates a flowchart of an example method in accordance with one or more embodiments of the present disclosure;

FIG. 11 illustrates a flowchart of an example method in accordance with one or more embodiments of the present disclosure; and

FIG. 12 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system, or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively, or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

### Overview

Example embodiments disclosed herein address technical problems associated with search event operations. As would be understood by one skilled in the field to which this disclosure pertains, there are numerous example scenarios in which it may be desirable to facilitate search event operations.

In many applications, systems, apparatuses, methods, and computer program products for search event operations are desirable. For example, it may be desirable for an aircraft to use a mobile search event operations apparatus, an onboard search event operations apparatus, and/or a cloud-based search event operations apparatus for facilitating search event operations. In this way, an aircraft can identify, assess, and navigate to a target device and/or a target associated with a search event operation in an efficient, accurate, and timely manner.

Example solutions for search event operations include using a computing device for facilitating search event operations. However, such example solutions are simplistic, inaccurate, resource intensive, and suffer from high latency. For example, such example solutions are simplistic because such example solutions are unable to automatically implement search event responsive actions that include detecting secondary devices in proximity to a target device. As another example, such example solutions are simplistic because such example solutions are unable to automatically implement search event responsive actions that include detecting a cellular tower in proximity to a target device and causing an aircraft to navigate towards the cellular tower. As another example, such example solutions are inaccurate because such example solutions do not leverage real-time target physical condition data accessed from a target device. As a result, such example solutions are unable to facilitate search event operations based on a real-time perspective of a search event. As another example, such example solutions are resource intensive because such example solutions are unable to leverage the detection and navigational capabilities of an aircraft for facilitating a search event operation while simultaneously conserving a battery level of a target device. As another example, such example solutions suffer from high latency because such example solutions are unable to dynamically leverage a mobile search event operations apparatus, an onboard search event operations apparatus, and/or a cloud-based search event operations apparatus for facilitating search event operations. Instead, such example solutions rely on a single computing device for facilitating search event operations. Accordingly, there is a need for systems, apparatuses, methods, and computer program products for facilitating search event operations in a sophisticated, accurate, low resource, and low latency manner.

Thus, to address these and/or other issues related to such example solutions, example systems, apparatuses, methods, and computer program products for search event operations are disclosed herein. For example, an embodiment, in this disclosure, described in greater detail below, includes a method that includes receiving search event data representative of a search event. In some embodiments, the method includes accessing real-time target physical condition data from a target device. In some embodiments, the real-time target physical condition data is representative of one or more real-time target physical condition items. In some embodiments, the method includes generating a target physical condition interface component based on the real-time target physical condition data. In some embodiments, the target physical condition interface component comprises the one or more real-time target physical condition items. In some embodiments, the method includes generating a search event access interface component. In some embodiments, the search event access interface component comprises one or more access links. In some embodiments, the method includes causing the target physical condition interface component to be rendered to a search event operations interface in response to a selection of a target physical condition access link of the one or more access links. Accordingly, the systems, apparatuses, methods, and computer program products disclosed herein enable search event operations in a sophisticated, accurate, low resource, and low latency manner.

### Example Systems and Apparatuses

Embodiments of the present disclosure herein include systems, apparatuses, methods, and computer program products configured for search event operations. It should be readily appreciated that the embodiments of the apparatus, systems, methods, and computer program product described herein may be configured in various additional and alternative manners in addition to those expressly described herein.

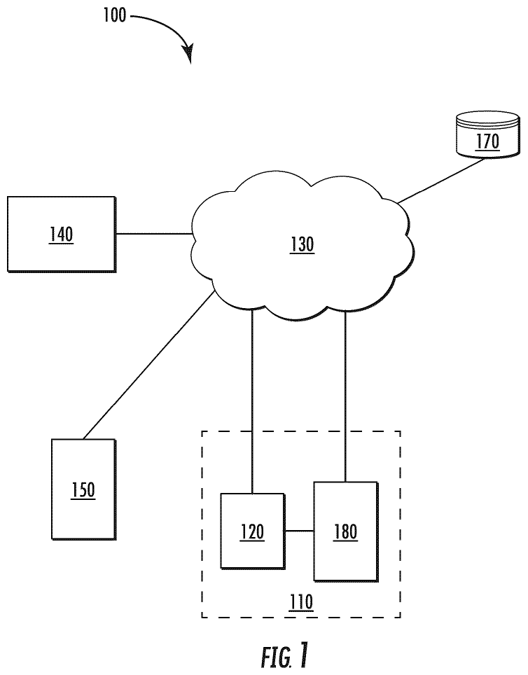

FIG. 1 illustrates an example block diagram of an environment 100 in which embodiments of the present disclosure may operate. Specifically, FIG. 1 illustrates an aircraft 110. In some embodiments, the aircraft 110 may describe any machine, robot, computing devices, and/or apparatus comprised of hardware, software, firmware, and/or any combination thereof, that maneuvers throughout an environment through a medium, such as air. In some contexts, the aircraft 110 is utilized to transport objects, entities (e.g., people, animals, or other beings), and/or other onboard cargo. In some situations, the aircraft 110 may be transporting no object except for the aircraft itself. Examples of the aircraft 110 include airplanes, helicopters, drones, and/or the like. In some embodiments, the aircraft 110 is not limited to the examples listed herein and may include other types of transportation device.

In some embodiments, the aircraft 110 is associated with a determinable location. The determinable location of the aircraft 110 in some embodiments represents an absolute position (e.g., GPS coordinates, latitude and longitude locations, an address, and/or the like) or a relative position of the aircraft 110 (e.g., an identifier representing the location of the aircraft 110 as compared to one or more other aircraft, one or more buildings (e.g., an airport), a proximity to a target device 150, an enterprise headquarters, or general description in the world for example based at least in part on continent, state, ocean, or other definable region). In some embodiments, the aircraft 110 includes or otherwise is associated with a location sensor and/or software-driven location services that provide the location data corresponding to the aircraft 110. In other embodiments, the location of the aircraft 110 is stored and/or otherwise determinable to one or more systems.

In some embodiments, the environment 100 illustrated in FIG. 1 includes the target device 150. In some embodiments, the target device 150 may correspond to a target (e.g., an individual) associated with a search event operation. For example, the target device 150 may be a device (e.g., a wearable device, such as a wearable watch) associated with a lost and/or injured individual that is the subject of a search and rescue operation. In some embodiments, the target device 150 is electronically and/or communicatively coupled to the aircraft 110, a mobile search event operations apparatus 120, cloud-based search event operations apparatus 140, an onboard search event operations apparatus 180, the target device 150, and/or one or more databases 170.

In some embodiments, the environment 100 includes a cloud-based search event operations apparatus 140. In some embodiments, the cloud-based search event operations apparatus 140 is electronically and/or communicatively coupled to the aircraft 110, a mobile search event operations apparatus 120, an onboard search event operations apparatus 180, the target device 150, and/or one or more databases 170. In some embodiments, the cloud-based search event operations apparatus 140 may comprise a flight management system (FMS) and/or the like. The cloud-based search event operations apparatus 140 may be located remotely from the aircraft 110. In this regard, for example, the cloud-based search event operations apparatus 140 may be located in a remote cloud server and electronically and/or communicatively coupled to the aircraft 110, the mobile search event operations apparatus 120, the onboard search event operations apparatus 180, the target device 150, and/or the one or more databases 170 via at least the network 130. In some embodiments, the cloud-based search event operations apparatus 140 is configured via hardware, software, firmware, and/or a combination thereof, to perform data intake of one or more types of data, such as search event data, real-time target physical condition data, static target physical condition data, target tracking data, historical search event data, target device activity data, and/or the like.

Additionally, or alternatively, in some embodiments, the cloud-based search event operations apparatus 140 is configured via hardware, software, firmware, and/or a combination thereof, to generate and/or transmit command(s) that control, adjust, or otherwise impact operations of one or more of the aircraft 110, the mobile search event operations apparatus 120, the onboard search event operations apparatus 180, the target device 150, and/or the one or more databases 170. For example, the cloud-based search event operations apparatus 140 may be configured to perform search event operations. Additionally, or alternatively, in some embodiments, the cloud-based search event operations apparatus 140 is configured via hardware, software, firmware, and/or a combination thereof, to perform data reporting, provide data, and/or other data output process(es) associated with monitoring or otherwise analyzing operations of one or more of the aircraft 110, the mobile search event operations apparatus 120, the onboard search event operations apparatus 180, the target device 150, and/or the one or more databases 170. For example, in various embodiments, the cloud-based search event operations apparatus 140 may be configured to execute and/or perform one or more operations and/or functions described herein.

In some embodiments, the environment 100 includes the mobile search event operations apparatus 120. In some embodiments, the mobile search event operations apparatus 120 is electronically and/or communicatively coupled to the aircraft 110, the cloud-based search event operations apparatus 140, the onboard search event operations apparatus 180, the target device 150, and/or the one or more databases 170. The mobile search event operations apparatus 120 may be located remotely from the aircraft 110, in proximity of the aircraft 110 (e.g., with a search event team member at a staging location associated with the aircraft 110), and/or within the aircraft 110 (e.g., with a search event team member in the aircraft 110). In some embodiments, the mobile search event operations apparatus 120 may comprise a flight management system (FMS) and/or the like. In this regard, for example, the mobile search event operations apparatus 120 may be portable. In some embodiments, the mobile search event operations apparatus 120 is configured via hardware, software, firmware, and/or a combination thereof, to perform data intake of one or more types of data, such as search event data, real-time target physical condition data, static target physical condition data, target tracking data, historical search event data, target device activity data, and/or the like.

Additionally, or alternatively, in some embodiments, the mobile search event operations apparatus 120 is configured via hardware, software, firmware, and/or a combination thereof, to generate and/or transmit command(s) that control, adjust, or otherwise impact operations of one or more of the aircraft 110, the cloud-based search event operations apparatus 140, the onboard search event operations apparatus 180, the target device 150, and/or the one or more databases 170. For example, the mobile search event operations apparatus 120 may be configured to perform search event operations. Additionally, or alternatively, in some embodiments, the mobile search event operations apparatus 120 is configured via hardware, software, firmware, and/or a combination thereof, to perform data reporting, provide data, and/or other data output process(es) associated with monitoring or otherwise analyzing operations of one or more of the aircraft 110, the cloud-based search event operations apparatus 140, the onboard search event operations apparatus 180, the target device 150, and/or the one or more databases 170. For example, in various embodiments, the mobile search event operations apparatus 120 may be configured to execute and/or perform one or more operations and/or functions described herein.

In some embodiments, the environment 100 includes the onboard search event operations apparatus 180. In some embodiments, the onboard search event operations apparatus 180 is electronically and/or communicatively coupled to the aircraft 110, the cloud-based search event operations apparatus 140, the mobile search event operations apparatus 120, the target device 150, and/or the one or more databases 170. The onboard search event operations apparatus 180 may be located within the aircraft 110 (e.g., as a component of the aircraft 110). In this regard, for example, the onboard search event operations apparatus 180 may physically secured to the aircraft 110. In some embodiments, the onboard search event operations apparatus 180 may comprise a flight management system (FMS) and/or the like. In some embodiments, the onboard search event operations apparatus 180 is configured via hardware, software, firmware, and/or a combination thereof, to perform data intake of one or more types of data, such as search event data, real-time target physical condition data, static target physical condition data, target tracking data, historical search event data, target device activity data, and/or the like.

Additionally, or alternatively, in some embodiments, the onboard search event operations apparatus 180 is configured via hardware, software, firmware, and/or a combination thereof, to generate and/or transmit command(s) that control, adjust, or otherwise impact operations of one or more of the aircraft 110, the cloud-based search event operations apparatus 140, the mobile search event operations apparatus 120, the target device 150, and/or the one or more databases 170. For example, the onboard search event operations apparatus 180 may be configured to perform search event operations. Additionally, or alternatively, in some embodiments, the onboard search event operations apparatus 180 is configured via hardware, software, firmware, and/or a combination thereof, to perform data reporting, provide data, and/or other data output process(es) associated with monitoring or otherwise analyzing operations of one or more of the aircraft 110, the cloud-based search event operations apparatus 140, the mobile search event operations apparatus 120, the target device 150, and/or the one or more databases 170. For example, in various embodiments, the onboard search event operations apparatus 180 may be configured to execute and/or perform one or more operations and/or functions described herein.

In some embodiments, the environment 100 may include search event operations apparatus. In some embodiments, the search event operations apparatus may be at least partially embodied as the mobile search event operations apparatus 120. Additionally, or alternatively, the search event operations apparatus may be at least partially embodied as the onboard search event operations apparatus 180. Additionally, or alternatively, the search event operations apparatus may be at least partially embodied as the cloud-based search event operations apparatus 140.

The one or more databases 170 may be configured to receive, store, and/or transmit data. For example, the one or more databases 170 may be configured to receive, store, and/or transmit data associated with the aircraft 110, the cloud-based search event operations apparatus 140, the mobile search event operations apparatus 120, the target device 150, the one or more databases 170, and/or the onboard search event operations apparatus 180. In this regard, for example, the one or more databases 170 may be configured to receive, store, and/or transmit such as search event data, real-time target physical condition data, static target physical condition data, target tracking data, historical search event data, target device activity data, and/or the like. The one or more databases 170 may be located remotely from the aircraft 110, in proximity of the aircraft 110, and/or within the aircraft 110. In some embodiments, the one or more databases 170 may be representative of one or more static target physical condition databases, target proximity databases, historical search event databases, and/or the like.

The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the cloud-based search event operations apparatus 140 may include the one or more databases 170.

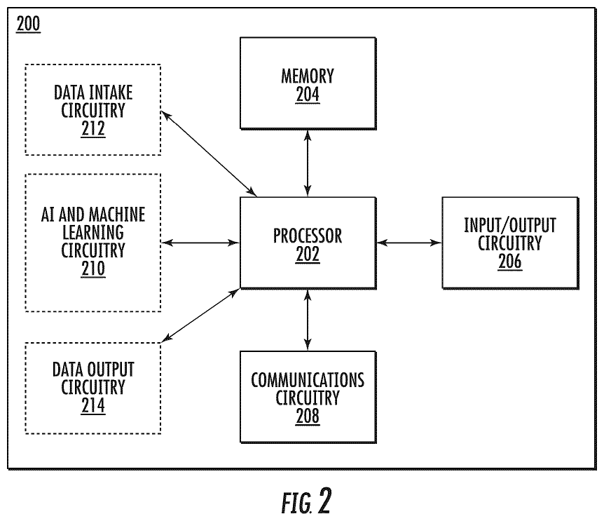

FIG. 2 illustrates an example block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. For example, the computing apparatus 200 may be embodied as one or more of a specifically configured personal computing apparatus, a specifically configured cloud-based computing apparatus, a specifically configured embedded computing device (e.g., configured for edge computing, and/or the like). Examples of an apparatus 200 may include, but is not limited to, the aircraft 110, the cloud-based search event operations apparatus 140, the mobile search event operations apparatus 120, the target device 150, the one or more databases 170, and/or the onboard search event operations apparatus 180. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, such as computing apparatus 200 of the cloud-based search event operations apparatus 140, the mobile search event operations apparatus 120, the target device 150, the one or more databases 170, and/or the onboard search event operations apparatus 180 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuitry 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally, or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of the aircraft 110. In some embodiments, the data intake circuitry 212 includes hardware, software, firmware, and/or a combination thereof, that communicates with one or more sensor(s) component(s), and/or the like within the aircraft 110 to receive particular data associated with such operations of the aircraft 110. Additionally, or alternatively, in some embodiments, the data intake circuitry 212 includes hardware, software, firmware, and/or a combination thereof, that retrieves particular data associated with the aircraft 110 from one or more data repository/repositories accessible to the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured for facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally, or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally, or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally, or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally, or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect to the AI and machine learning circuitry 210.

With reference to FIGS. 1-9, in some embodiments, the search event operations apparatus (e.g., the mobile search event operations apparatus 120, the onboard search event operations apparatus 180, and/or the cloud-based search event operations apparatus 140) is configured to receive search event data. In some embodiments, search event data includes one or more items of data representative and/or indicative of a search event associated with a target and/or the target device 150. In some embodiments, a search event includes a search event operation associated with a target and/or the target device 150. For example, a search event operation may include a search and rescue operation for a target and/or the target device 150. In some embodiments, a target is an individual and/or group of individuals that are lost and/or injured and need to be found and/or rescued. In this regard, for example, search event data may include one or more items of data representative and/or indicative of information associated with a search and rescue operation.

In some embodiments, the search event operations apparatus (e.g., the mobile search event operations apparatus 120, the onboard search event operations apparatus 180, and/or the cloud-based search event operations apparatus 140) is configured to access real-time target physical condition data. In some embodiments, real-time target physical condition data includes one or more items of data representative and/or indicative of one or more real-time target physical condition items. In some embodiments, a real-time target physical condition item is indicative of one or more real-time target physical condition parameters associated with a target (e.g., a target associated with the target device 150). For example, a real-time target physical condition item may be indicative of a heart rate associated with a target (e.g., a heart rate of 75 beats per minute). As another example, a real-time target physical condition item may be indicative of an oxygen saturation associated with a target (e.g., an SPO2 of 85%). As another example, a real-time target physical condition item may be indicative of an insulin level (e.g., an insulin level of 17). As another example, a real-time target physical condition item may be indicative of a blood pressure associated with a target (e.g., a blood pressure of 120/80).

In some embodiments, the search event operations apparatus (e.g., the mobile search event operations apparatus 120, the onboard search event operations apparatus 180, and/or the cloud-based search event operations apparatus 140) is configured to access real-time target physical condition data from the target device 150. In this regard, for example, the target device 150 may include one or more sensors configured to capture and/or generate real-time target physical condition data. For example, when the target device 150 is a wearable device (e.g., a smart watch), the wearable device may include one or more sensors to capture and/or generate real-time target physical condition data. In some embodiments, the search event operations apparatus is configured to access real-time target physical condition data in response to receiving search event data.

In some embodiments, the search event operations apparatus (e.g., the mobile search event operations apparatus 120, the onboard search event operations apparatus 180, and/or the cloud-based search event operations apparatus 140) is configured to access real-time target physical condition data in real-time. In this regard, for example, the search event operations apparatus may be configured to continually access real-time target physical condition data from the target device 150 to get updated real-time target physical condition data. For example, the search event operations apparatus may be configured to access real-time target physical condition data every two seconds. Said differently, the search event operations apparatus may be configured to obtain a real-time view of a target's physical condition.

In some embodiments, the search event operations apparatus (e.g., the mobile search event operations apparatus 120, the onboard search event operations apparatus 180, and/or the cloud-based search event operations apparatus 140) is configured to access static target physical condition data. In some embodiments, static target physical condition data includes one or more items of data representative and/or indicative of one or more static target physical condition items. In some embodiments, a static target physical condition item is indicative of one or more static target physical condition parameters associated with a target (e.g., a target associated with the target device 150). For example, a static target physical condition item may be indicative of a diabetic status associated with a target (e.g., a diabetic status of yes). Said differently, static target physical condition items may be indicative of one or more target physical condition parameters associated with a target that are constant during a search event while real-time target physical conditions may be indicative of one or more target physical condition parameters associated with a target that fluctuate during a search event.

In some embodiments, the search event operations apparatus (e.g., the mobile search event operations apparatus 120, the onboard search event operations apparatus 180, and/or the cloud-based search event operations apparatus 140) is configured to access static target physical condition data from one or more static target physical condition databases. For example, the search event operations apparatus may be configured to access static target physical condition data from a static target physical condition database associated with a connected health system. In this regard, for example, a target associated with the target device 150 may have previously provided static target physical condition data to a static target physical condition database (e.g., before a search event).

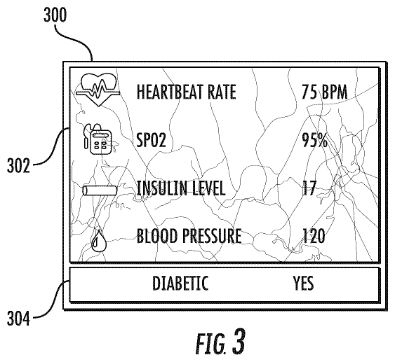

In some embodiments, the search event operations apparatus (e.g., the mobile search event operations apparatus 120, the onboard search event operations apparatus 180, and/or the cloud-based search event operations apparatus 140) is configured to generate a target physical condition interface component 300, such as illustrated in FIG. 3. In some embodiments, the search event operations apparatus is configured to generate the target physical condition interface component 300 based on real-time target physical condition data. In this regard, for example, the target physical condition interface component 300 may include one or more real-time target physical condition items 302. For example, the target physical condition interface component 300 may include a heart rate, an oxygen saturation, an insulin level, and/or a blood pressure. In some embodiments, the target physical condition interface component 300 is configured such that the one or more real-time target physical condition items 302 are updated in real-time. In this regard, for example, the target physical condition interface component 300 is configured to provide one or more real-time target physical condition parameters associated with a target.

Additionally, or alternatively, the search event operations apparatus (e.g., the mobile search event operations apparatus 120, the onboard search event operations apparatus 180, and/or the cloud-based search event operations apparatus 140) is configured to generate a target physical condition interface component 300 based on static target physical condition data. In this regard, for example, the target physical condition interface component 300 may include one or more static target physical condition items 304. For example, the target physical condition interface component 300 may include a diabetic status.

In some embodiments, the search event operations apparatus (e.g., the mobile search event operations apparatus 120, the onboard search event operations apparatus 180, and/or the cloud-based search event operations apparatus 140) is configured to access target device activity data. In some embodiments, target device activity data includes one or more items of data representative and/or indicative of one or more target device activity items. In some embodiments, a target device activity item is indicative of one or more parameters associated with the target device. For example, a target device activity item may be indicative of a mobility rate associated with the target device (e.g., 1 mile per hour). In this regard, for example, a mobility rate may be an indicative of how far the target device 150 has moved in a defined time period. As another example, a target device activity item may be indicative of a static since time (e.g., 9:00). In this regard, for example, a static since time may be indicative of an amount of time since the target device 150 has moved. As another example, a target device activity item may be indicative of a last known position (e.g., a latitude and longitude). In this regard, for example, a last known position may be indicative of a last known position of the target device 150. As another example, a target device activity item may be indicative of a battery level (e.g., 22%). In this regard, for example, a battery level may be indicative of an amount of battery life that the target device 150 has remaining. As another example, a target device activity item may be indicative of a signal strength (e.g., 2 out of 5).

In some embodiments, the search event operations apparatus (e.g., the mobile search event operations apparatus 120, the onboard search event operations apparatus 180, and/or the cloud-based search event operations apparatus 140) is configured to access target device activity data from the target device 150. In this regard, for example, the target device 150 may include one or more sensors configured to capture and/or generate target device activity data. Additionally, or alternatively, the search event operations apparatus is configured to access target device activity data from a cellular network. For example, the search event operations apparatus may be configured to access target device activity data from a cellular tower in proximity to the target device 150. Additionally, or alternatively, the search event operations apparatus is configured to access target device activity data from a global positioning system (GPS) network. For example, the search event operations apparatus may be configured to access target device activity data from a satellite in proximity to the target device 150.

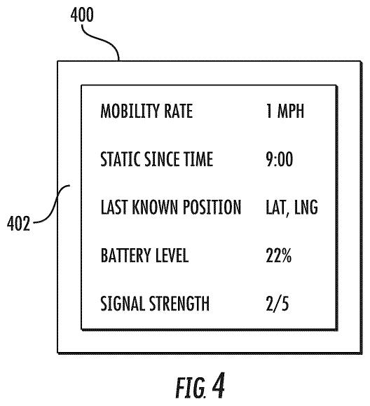

In some embodiments, the search event operations apparatus (e.g., the mobile search event operations apparatus 120, the onboard search event operations apparatus 180, and/or the cloud-based search event operations apparatus 140) is configured to generate a target device activity interface component 400, such as illustrated in FIG. 4. In some embodiments, the search event operations apparatus is configured to generate the target device activity interface component 400 based on target device activity data. In this regard, for example, the target device activity interface component 400 may include one or more target device activity items 402. For example, the target device activity interface component 400 may include a mobility rate, a static since time, a last known position, a signal strength, and/or the like.

In some embodiments, the search event operations apparatus (e.g., the mobile search event operations apparatus 120, the onboard search event operations apparatus 180, and/or the cloud-based search event operations apparatus 140) is configured to access target proximity data. In some embodiments, target proximity data includes one or more items of data representative and/or indicative of one or more geographical features and/or structures in proximity to the target device 150. For example, target proximity data may be indicative of one or more accessible pathways in proximity to the target device 150. In this regard, for example, an accessible pathway may include one or more trails, roads, and/or the like. As another example, target proximity data may be indicative of one or more topographical features in proximity to the target device 150 (e.g., a mountain, hill, body of water, etc.). In this regard, for example, a topographical feature may include one or more mountains, hills, bodies of water, and/or the like. As another example, target proximity data may be indicative of one or more cellular towers (e.g., a mobile tower) in proximity to the target device 150.

In some embodiments, the search event operations apparatus (e.g., the mobile search event operations apparatus 120, the onboard search event operations apparatus 180, and/or the cloud-based search event operations apparatus 140) is configured to access target proximity data from the target device 150. Additionally, or alternatively, the search event operations apparatus is configured to access target proximity data from one or more target proximity databases. For example, the search event operations apparatus may be configured to access target proximity data from a target proximity database associated with a mapping service.

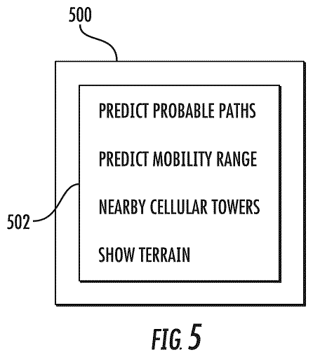

In some embodiments, the search event operations apparatus (e.g., the mobile search event operations apparatus 120, the onboard search event operations apparatus 180, and/or the cloud-based search event operations apparatus 140) is configured to generate a target proximity interface component 500, such as illustrated in FIG. 5. In some embodiments, the search event operations apparatus is configured to generate the target proximity interface component 500 based on target proximity data. In this regard, for example, the target proximity interface component 500 may include one or more target proximity action items 502. For example, the target proximity interface component 500 may include a target proximity action item that is associated with predicting probable pathways. As another example, the target proximity interface component 500 may include a target proximity action item that is associated with predicting a mobility range. As another example, the target proximity interface component 500 may include a target proximity action item that is associated with predicting nearby cellular towers (e.g., nearby mobile towers). As another example, the target proximity interface component 500 may include a target proximity action item that is associated with showing terrain.

In some embodiments, the one or more target proximity action items 502 are selectable. In this regard, for example, the one or more target proximity action items 502 may be selectable to predict a probable pathway to the target device 150 (e.g., from a specified location, from the aircraft 110, etc.). As another example, the one or more target proximity action items 502 may be selectable to predict a mobility range of a target associated with the target device 150 (e.g., how far a target can likely travel based on topographical features near the target device 150). As another example, the one or more target proximity action items 502 may be selectable to predict cellular towers near the target device 150. As another example, the one or more target proximity action items 502 may be selectable to show the terrain near the target device 150.

In some embodiments, the search event operations apparatus (e.g., the mobile search event operations apparatus 120, the onboard search event operations apparatus 180, and/or the cloud-based search event operations apparatus 140) is configured to access historical search event data. In some embodiments, historical search event data includes one or more items of data representative and/or indicative of one or more historical search events. For example, historical search event data may be indicative of one or more patterns flown by the aircraft 110 and/or one or more other aircraft during a historical search event. As another example, historical search event data may be indicative of one or more landing zones used by the aircraft 110 and/or one or more other aircraft during a historical search event. As another example, historical search event data may be indicative of one or more hover zones used by the aircraft 110 and/or one or more other aircraft during a historical search event. As another example, historical search event data may be indicative of terrain in proximity to the target device 150.

In some embodiments, the search event operations apparatus (e.g., the mobile search event operations apparatus 120, the onboard search event operations apparatus 180, and/or the cloud-based search event operations apparatus 140) is configured to access historical search event data from the target device 150. Additionally, or alternatively, the search event operations apparatus is configured to access historical search event data from one or more historical search event databases. For example, the search event operations apparatus may be configured to access historical search event data from a historical search event database associated with the search event operations apparatus.

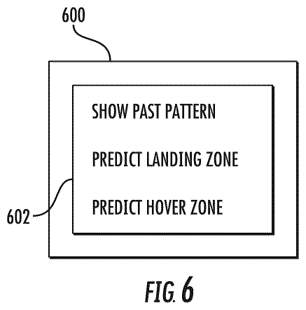

In some embodiments, the search event operations apparatus (e.g., the mobile search event operations apparatus 120, the onboard search event operations apparatus 180, and/or the cloud-based search event operations apparatus 140) is configured to generate a historical search event interface component 600, such as illustrated in FIG. 6. In some embodiments, the search event operations apparatus is configured to generate the historical search event interface component 600 based on historical search event data. In this regard, for example, the historical search event interface component 600 may include one or more historical search event action items 602. For example, the historical search event interface component 600 may include a historical search event action item that is associated with showing one or more historical flight patterns used by the aircraft 110. As another example, the historical search event interface component 600 may include a historical search event action item that is associated with predicting a landing zone. As another example, the historical search event interface component 600 may include a historical search event action item that is associated with predicting a landing zone. As another example, the historical search event interface component 600 may include a historical search event action item that is associated with predicting a hover zone.

In some embodiments, the one or more historical search event action items 602 are selectable. In this regard, for example, the one or more historical search event action items 602 may be selectable to show a historical flight pattern used by the aircraft 110 and/or one or more other aircraft (e.g., when searching for the target device 150 a target, a historical target, and/or a historical target device). As another example, the one or more historical search event action items 602 may be selectable to predict a landing zone (e.g., a landing zone near the target device 150 and/or a target). In this regard, for example, predicting a landing zone may include the search event operations apparatus and/or the aircraft 110 being configured to analyzing the terrain using historical search event data and/or a camera associated with the aircraft 110 to identify whether a particular area is suitable for being used as a landing zone (e.g., is an area flat, level, of sufficient size, etc.) As another example, the one or more historical search event action items 602 may be selectable to predict a hover zone (e.g., a hover zone near the target device 150 and/or a target). In some embodiments, the search event operations apparatus and/or the aircraft 110 is configured to predict a hover zone when the search event operations apparatus predicts that an area is not suitable for being used as a landing zone. In this regard, for example, predicting a hover zone may include the search event operations apparatus and/or the aircraft 110 being configured to analyze terrain using historical search event data and/or a camera associated with the aircraft 110 and determine that a particular area is not suitable for being used as a landing zone (e.g., is an area flat, level, of sufficient size, etc.). Said differently, for example, when there is not a suitable landing zone the search event operations apparatus may be configured to cause the aircraft 110 to hover.

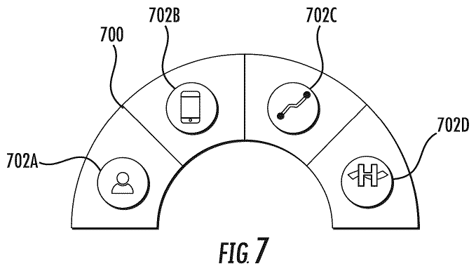

In some embodiments, the search event operations apparatus (e.g., the mobile search event operations apparatus 120, the onboard search event operations apparatus 180, and/or the cloud-based search event operations apparatus 140) is configured to generate a search event access interface component 700, such as illustrated in FIG. 7. In some embodiments, the search event access interface component 700 includes one or more access links.

In some embodiments, the one or more access links includes a target physical condition access link 702A corresponding to the target physical condition interface component 300. In some embodiments, the target physical condition access link 702A is selectable. In some embodiments, the one or more access links includes a target device activity access link 702B corresponding to the target device activity interface component 400. In some embodiments, the target device activity access link 702B is selectable. In some embodiments, the one or more access links includes a target proximity access link 702C corresponding to the target proximity interface component 500. In some embodiments, the target proximity access link 702C is selectable. In some embodiments, the one or more access links includes a historical search event access link 702D corresponding to the historical search event interface component 600. In some embodiments, the historical search event access link 702D is selectable.

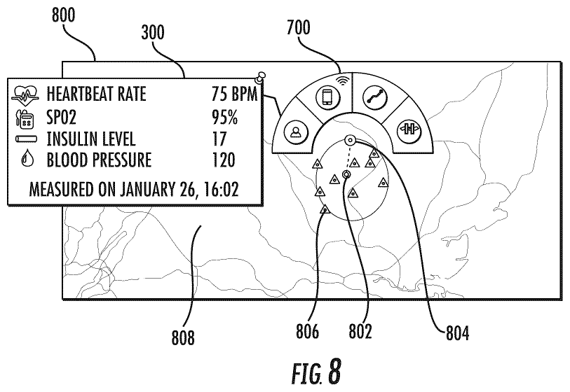

In some embodiments, the search event operations apparatus (e.g., the mobile search event operations apparatus 120, the onboard search event operations apparatus 180, and/or the cloud-based search event operations apparatus 140) is configured to cause the search event access interface component 700 to be rendered to a search event operations interface 800, such as illustrated in FIG. 8. In some embodiments, the search event operations apparatus is configured to cause the target physical condition interface component 300 to be rendered to the search event operations interface 800, such as illustrated in FIG. 8. In some embodiments, the target physical condition interface component 300 is rendered to the search event operations interface 800 in response to a selection of the target physical condition access link 702A.

In some embodiments, the search event operations apparatus (e.g., the mobile search event operations apparatus 120, the onboard search event operations apparatus 180, and/or the cloud-based search event operations apparatus 140) is configured to cause the target device activity interface component 400 to be rendered to the search event operations interface 800. In some embodiments, the target device activity interface component 400 is rendered to the search event operations interface 800 in response to a selection of the target device activity access link 702B. In some embodiments, the search event operations apparatus is configured to cause the target proximity interface component 500 to be rendered to the search event operations interface 800. In some embodiments, the target proximity interface component 500 is rendered to the search event operations interface 800 in response to a selection of the target proximity access link 702C. In some embodiments, the search event operations apparatus is configured to cause the historical search event interface component 600 to be rendered to the search event operations interface 800. In some embodiments, the historical search event interface component 600 is rendered to the search event operations interface 800 in response to a selection of the historical search event access link 702D.

In some embodiments, the search event operations interface 800 includes a representation 802 of the aircraft 110. Additionally, or alternatively, the search event operations interface 800 includes a representation 804 of the target device 150. Additionally, or alternatively, the search event operations interface 800 includes a representation 806 of one or more secondary devices. For example, the one or more secondary devices may be devices that are in proximity to the target device 150 and/or the aircraft 110 (e.g., within in a defined distance from the target device 150 and/or the aircraft 110). Additionally, or alternatively, the search event operations interface 800 includes a representation 808 of the area in proximity to the target device 150 and/or the aircraft 110 (e.g., a map of the area in proximity to the target device 150 and/or the aircraft 110).

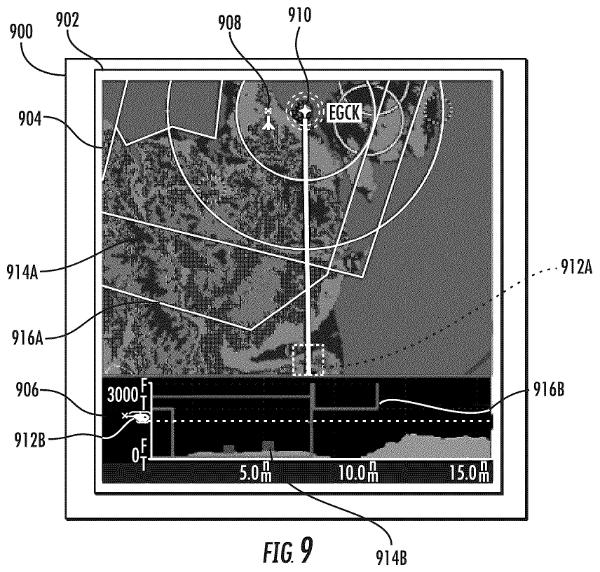

In some embodiments, the search event operations apparatus (e.g., the mobile search event operations apparatus 120, the onboard search event operations apparatus 180, and/or the cloud-based search event operations apparatus 140) is configured to generate a search zone interface component 902. In some embodiments, the search event operations apparatus is configured to cause the search zone interface component 902 to be rendered to a search zone interface 900, such as illustrated in FIG. 9. In some embodiments, the search zone interface component 902 is generated using real-time target physical condition data, search event data, static target physical condition data, target device activity data, target proximity data, and/or historical search event data.

In some embodiments, the search zone interface component 902 includes a vertical view sub-interface component 904. In some embodiments, the vertical view sub-interface component 904 is configured to provide a top-down view of an area associated with a search event. In some embodiments, the vertical view sub-interface component 904 includes a representation 908 of a cellular tower. In some embodiments, the vertical view sub-interface component 904 includes a representation 910 of the target device 150 and/or a target associated with the target device 150. In some embodiments, the vertical view sub-interface component 904 includes a representation 912A of the aircraft 110. In some embodiments, the vertical view sub-interface component 904 includes a representation 914A of one or more unsafe landing zones (e.g., based on terrain conditions). In some embodiments, the vertical view sub-interface component 904 includes a representation 916A of one or more search area (e.g., a line, box, etc. that delineates a search area).

In some embodiments, the search zone interface component 902 includes a horizontal view sub-interface component 906. In some embodiments, the horizontal view sub-interface component 906 is configured to provide a side view of an area associated with a search event. In some embodiments, the horizontal view sub-interface component 906 includes a representation 912B of the aircraft 110. In some embodiments, the horizontal view sub-interface component 906 includes a representation 914B of one or more unsafe landing zones (e.g., based on terrain conditions). In some embodiments, the horizontal view sub-interface component 906 includes a representation 916B of one or more search area (e.g., a line, box, etc. that delineates a search area).

In some embodiments, the search event operations apparatus (e.g., the mobile search event operations apparatus 120, the onboard search event operations apparatus 180, and/or the cloud-based search event operations apparatus 140) is configured to initiate performance of one or more search event responsive actions. For example, the search event operations apparatus may be configured to initiate performance of one or more search event responsive actions using real-time target physical condition data, search event data, static target physical condition data, target device activity data, target proximity data, and/or historical search event data.

In some embodiments, initiating performance of one or more search event responsive actions includes the search event operations apparatus being configured to transmit an action message to the target device 150. For example, an action message may include an indication that instructs a target to move to a predicted landing zone. As another example, an action message may include an indication that instructs a target to move to calm down (e.g., when the real-time target physical condition data indicates that a target's heart rate is above a particular threshold). As another example, an action message may include an indication that informs a target of an estimated time of arrival of a rescue vehicle.

In some embodiments, initiating performance of one or more search event responsive actions includes the search event operations apparatus being configured to transmit an instruction message to an enterprise device. For example, an instruction message may be transmitted to an enterprise device associated with a health care system. In some embodiments, the instruction message includes real-time target physical condition data. In this regard, for example, a health care system associated with the enterprise device can begin to prepare to treat a target before the target is recused.

In some embodiments, initiating performance of one or more search event responsive actions includes the search event operations apparatus being configured to detect one or more secondary devices in proximity to the target device 150. In some embodiments, initiating performance of one or more search event responsive actions includes the search event operations apparatus being configured to transmit an alert message to the one or more secondary devices. In some embodiments, an alert message includes an indication that there is a search event occurring in proximity to the one or more secondary devices. In this regard, for example, individuals associated with the one or more secondary devices can be made aware of the search event and/or assist in locating a target and/or the target device 150.

In some embodiments, initiating performance of one or more search event responsive actions includes the search event operations apparatus being configured to detect a cellular tower (e.g., a mobile tower) in proximity to the target device 150. In some embodiments, initiating performance of one or more search event responsive actions includes the search event operations apparatus being configured to cause the aircraft 110 to navigate towards the cellular tower in response to detecting the cellular tower in proximity to the target device 150. In this regard, for example, the aircraft 110 is able to navigate towards the target device 150 without relying on signals and/or directions from the target device 150. As a result, a battery level associated with the target device 150 can be conserved.

### Example Methods

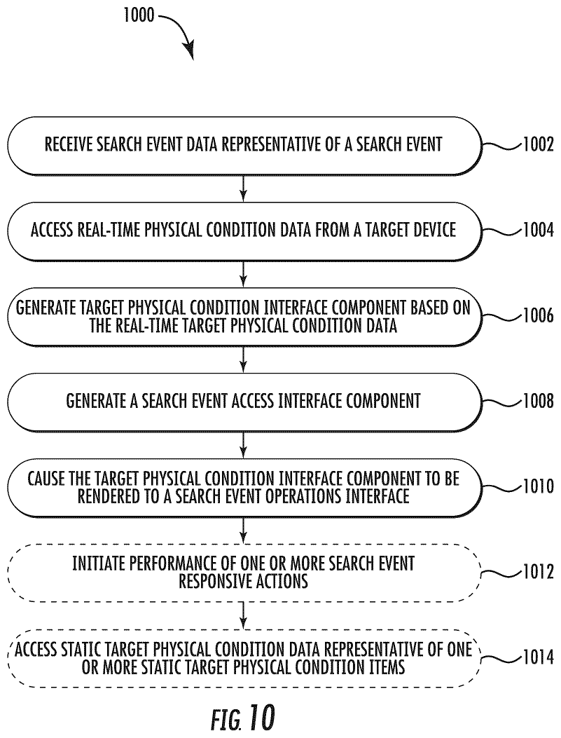

Referring now to FIG. 10, a flowchart providing an example method 1000 is illustrated. In this regard, FIG. 10 illustrates operations that may be performed by the search event operations apparatus (e.g., the mobile search event operations apparatus 120, the onboard search event operations apparatus 180, and/or the cloud-based search event operations apparatus 140), the target device 150, the aircraft 110, and/or the one or more databases 170. In some embodiments, the method 1000 includes operations for causing a target physical condition interface component to be rendered to a search event operations interface. In some embodiments, the example method 1000 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1000.

As shown in block 1002, the method 1000 may include receiving search event data representative of a search event. As described above, in some embodiments, search event data includes one or more items of data representative and/or indicative of a search event associated with a target and/or the target device. In some embodiments, a search event includes a search event operation associated with a target and/or the target device. For example, a search event operation may include a search and rescue operation for a target and/or the target device. In some embodiments, a target is an individual and/or group of individuals that are lost and/or injured and need to be found and/or rescued. In this regard, for example, search event data may include one or more items of data representative and/or indicative of information associated with a search and rescue operation.

As shown in block 1004, the method 1000 may include accessing real-time target physical condition data from a target device. As described above, in some embodiments, real-time target physical condition data includes one or more items of data representative and/or indicative of one or more real-time target physical condition items. In some embodiments, a real-time target physical condition item is indicative of one or more real-time target physical condition parameters associated with a target (e.g., a target associated with the target device). For example, a real-time target physical condition item may be indicative of a heart rate associated with a target (e.g., a heart rate of 75 beats per minute). As another example, a real-time target physical condition item may be indicative of an oxygen saturation associated with a target (e.g., an SPO2 of 85%). As another example, a real-time target physical condition item may be indicative of an insulin level (e.g., an insulin level of 17). As another example, a real-time target physical condition item may be indicative of a blood pressure associated with a target (e.g., a blood pressure of/80).

In some embodiments, the search event operations apparatus (e.g., the mobile search event operations apparatus, the onboard search event operations apparatus, and/or the cloud-based search event operations apparatus) is configured to access real-time target physical condition data from the target device. In this regard, for example, the target device may include one or more sensors configured to capture and/or generate real-time target physical condition data. For example, when the target device is a wearable device (e.g., a smart watch), the wearable device may include one or more sensors to capture and/or generate real-time target physical condition data. In some embodiments, the search event operations apparatus is configured to access real-time target physical condition data in response to receiving search event data.

In some embodiments, the search event operations apparatus (e.g., the mobile search event operations apparatus, the onboard search event operations apparatus, and/or the cloud-based search event operations apparatus) is configured to access real-time target physical condition data in real-time. In this regard, for example, the search event operations apparatus may be configured to continually access real-time target physical condition data from the target device to get updated real-time target physical condition data. For example, the search event operations apparatus may be configured to access real-time target physical condition data every two seconds. Said differently, the search event operations apparatus may be configured to obtain a real-time view of a target's physical condition.

As shown in block 1006, the method 1000 may include generating a target physical condition interface component based on the real-time target physical condition data. As described above, in some embodiments, the search event operations apparatus is configured to generate the target physical condition interface component based on real-time target physical condition data. In this regard, for example, the target physical condition interface component may include one or more real-time target physical condition items. For example, the target physical condition interface component may include a heart rate, an oxygen saturation, an insulin level, and/or a blood pressure. In some embodiments, the target physical condition interface component is configured such that the one or more real-time target physical condition items are updated in real-time. In this regard, for example, the target physical condition interface component is configured to provide one or more real-time target physical condition parameters associated with a target.

Additionally, or alternatively, the search event operations apparatus (e.g., the mobile search event operations apparatus, the onboard search event operations apparatus, and/or the cloud-based search event operations apparatus) is configured to generate a target physical condition interface component based on static target physical condition data. In this regard, for example, the target physical condition interface component may include one or more static target physical condition items. For example, the target physical condition interface component may include a diabetic status.

As shown in block 1008, the method 1000 may include generating a search event access interface component. As described above, in some embodiments, the search event access interface component includes one or more access links.

In some embodiments, the one or more access links includes a target physical condition access link corresponding to the target physical condition interface component. In some embodiments, the target physical condition access link is selectable. In some embodiments, the one or more access links includes a target device activity access link corresponding to the target device activity interface component. In some embodiments, the target device activity access link is selectable. In some embodiments, the one or more access links includes a target proximity access link corresponding to the target proximity interface component. In some embodiments, the target proximity access link is selectable. In some embodiments, the one or more access links includes a historical search event access link corresponding to the historical search event interface component. In some embodiments, the historical search event access link is selectable.

As shown in block 1010, the method 1000 may include causing the target physical condition interface component to be rendered to a search event operations interface. As described above, in some embodiments, the search event operations apparatus is configured to cause the target physical condition interface component to be rendered to the search event operations interface, such as illustrated in FIG. 8. In some embodiments, the target physical condition interface component is rendered to the search event operations interface in response to a selection of the target physical condition access link.

As shown in optional block 1012, the method 1000 may optionally include initiating performance of one or more search event responsive actions. As described above, in some embodiments, the search event operations apparatus may be configured to initiate performance of one or more search event responsive actions using real-time target physical condition data, search event data, static target physical condition data, target device activity data, target proximity data, and/or historical search event data.

As shown in optional block 1014, the method 1000 may optionally include accessing static target physical condition data representative of one or more static target physical condition items. As described above, in some embodiments, static target physical condition data includes one or more items of data representative and/or indicative of one or more static target physical condition items. In some embodiments, a static target physical condition item is indicative of one or more static target physical condition parameters associated with a target (e.g., a target associated with the target device). For example, a static target physical condition item may be indicative of a diabetic status associated with a target (e.g., a diabetic status of yes). Said differently, static target physical condition items may be indicative of one or more target physical condition parameters associated with a target that are constant during a search event while real-time target physical conditions may be indicative of one or more target physical condition parameters associated with a target that fluctuate during a search event.

In some embodiments, the search event operations apparatus (e.g., the mobile search event operations apparatus, the onboard search event operations apparatus, and/or the cloud-based search event operations apparatus) is configured to access static target physical condition data from one or more static target physical condition databases. For example, the search event operations apparatus may be configured to access static target physical condition data from a static target physical condition database associated with a connected health system. In this regard, for example, a target associated with the target device may have previously provided static target physical condition data to a static target physical condition database (e.g., before a search event).

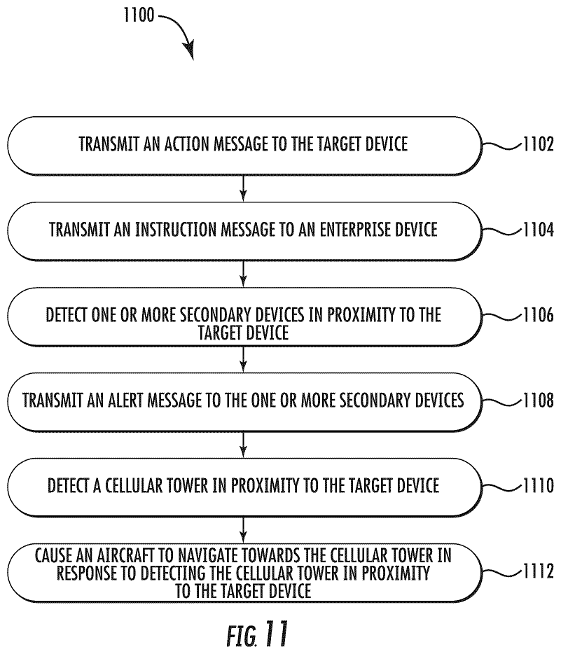

Referring now to FIG. 11, a flowchart providing an example method 1100 is illustrated. In this regard, FIG. 11 illustrates operations that may be performed by the search event operations apparatus (e.g., the mobile search event operations apparatus 120, the onboard search event operations apparatus 180, and/or the cloud-based search event operations apparatus 140), the target device 150, the aircraft 110, and/or the one or more databases 170. In some embodiments, the method 1100 includes operations for initiating performance of one or more search event responsive actions. In some embodiments, the example method 1100 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1100.

As shown in block 1102, the method 1100 may include transmitting an action message to the target device. As described above, in some embodiments, initiating performance of one or more search event responsive actions includes the search event operations apparatus being configured to transmit an action message to the target device. For example, an action message may include an indication that instructs a target to move to a predicted landing zone. As another example, an action message may include an indication that instructs a target to move to calm down (e.g., when the real-time target physical condition data indicates that a target's heart rate is above a particular threshold). As another example, an action message may include an indication that informs a target of an estimated time of arrival of a rescue vehicle.

As shown in block 1104, the method 1100 may include transmitting an instruction message to an enterprise device. As described above, in some embodiments, initiating performance of one or more search event responsive actions includes the search event operations apparatus being configured to transmit an instruction message to an enterprise device. For example, an instruction message may be transmitted to an enterprise device associated with a health care system. In some embodiments, the instruction message includes real-time target physical condition data. In this regard, for example, a health care system associated with the enterprise device can begin to prepare to treat a target before the target is recused.

As shown in block 1106, the method 1100 may include detecting one or more secondary devices in proximity to the target device. As shown in block 1108, the method 1100 may include transmitting an alert message to the one or more secondary devices. As described above, in some embodiments, an alert message includes an indication that there is a search event occurring in proximity to the one or more secondary devices. In this regard, for example, individuals associated with the one or more secondary devices can be made aware of the search event and/or assist in locating a target and/or the target device.

As shown in block 1110, the method 1200 may include detecting a cellular tower in proximity to the target device. As shown in block 1112, the method 1200 may include causing an aircraft to navigate towards the cellular tower in response to detecting the cellular tower in proximity to the target device. As described above, in some embodiments, initiating performance of one or more search event responsive actions includes the search event operations apparatus being configured to cause the aircraft to navigate towards the cellular tower in response to detecting the cellular tower in proximity to the target device. In this regard, for example, the aircraft is able to navigate towards the target device without relying on signals and/or directions from the target device. As a result, a battery level associated with the target device can be conserved.

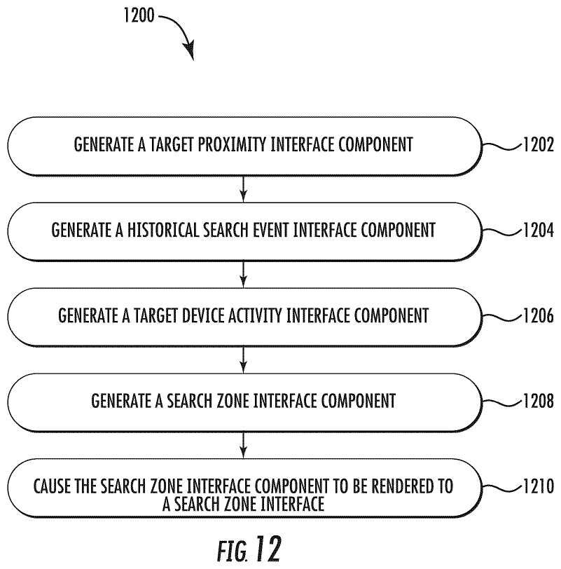

Referring now to FIG. 12, a flowchart providing an example method 1200 is illustrated. In this regard, FIG. 12 illustrates operations that may be performed by the search event operations apparatus (e.g., the mobile search event operations apparatus 120, the onboard search event operations apparatus 180, and/or the cloud-based search event operations apparatus 140), the target device 150, the aircraft 110, and/or the one or more databases 170. In some embodiments, the method 1200 includes operations for initiating performance of one or more search event responsive actions. In some embodiments, the example method 1200 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 1200.

As shown in block 1202, the method 1200 may include generating a target proximity interface component. As described above, in some embodiments, the search event operations apparatus (e.g., the mobile search event operations apparatus, the onboard search event operations apparatus, and/or the cloud-based search event operations apparatus) is configured to access target proximity data. In some embodiments, target proximity data includes one or more items of data representative and/or indicative of one or more geographical features and/or structures in proximity to the target device. For example, target proximity data may be indicative of one or more accessible pathways in proximity to the target device. In this regard, for example, an accessible pathway may include one or more trails, roads, and/or the like. As another example, target proximity data may be indicative of one or more topographical features in proximity to the target device (e.g., a mountain, hill, body of water, etc.). In this regard, for example, a topographical feature may include one or more mountains, hills, bodies of water, and/or the like. As another example, target proximity data may be indicative of one or more cellular towers (e.g., a mobile tower) in proximity to the target device.

In some embodiments, the search event operations apparatus (e.g., the mobile search event operations apparatus, the onboard search event operations apparatus, and/or the cloud-based search event operations apparatus) is configured to access target proximity data from the target device. Additionally, or alternatively, the search event operations apparatus is configured to access target proximity data from one or more target proximity databases. For example, the search event operations apparatus may be configured to access target proximity data from a target proximity database associated with a mapping service.

In some embodiments, the search event operations apparatus (e.g., the mobile search event operations apparatus, the onboard search event operations apparatus, and/or the cloud-based search event operations apparatus) is configured to generate a target proximity interface component, such as illustrated in FIG. 5. In some embodiments, the search event operations apparatus is configured to generate the target proximity interface component based on target proximity data. In this regard, for example, the target proximity interface component may include one or more target proximity action items. For example, the target proximity interface component may include a target proximity action item that is associated with predicting probable pathways. As another example, the target proximity interface component may include a target proximity action item that is associated with predicting a mobility range. As another example, the target proximity interface component may include a target proximity action item that is associated with predicting nearby cellular towers (e.g., nearby mobile towers). As another example, the target proximity interface component may include a target proximity action item that is associated with showing terrain.

In some embodiments, the one or more target proximity action items are selectable. In this regard, for example, the one or more target proximity action items may be selectable to predict a probable pathway to the target device (e.g., from a specified location, from the aircraft, etc.). As another example, the one or more target proximity action items may be selectable to predict a mobility range of a target associated with the target device (e.g., how far a target can likely travel based on topographical features near the target device). As another example, the one or more target proximity action items may be selectable to predict cellular towers near the target device. As another example, the one or more target proximity action items may be selectable to show the terrain near the target device.

As shown in block 1204, the method 1200 may include generating a historical search event interface component. As described above, in some embodiments, the search event operations apparatus (e.g., the mobile search event operations apparatus, the onboard search event operations apparatus, and/or the cloud-based search event operations apparatus) is configured to access target device activity data. In some embodiments, target device activity data includes one or more items of data representative and/or indicative of one or more target device activity items. In some embodiments, a target device activity item is indicative of one or more parameters associated with the target device. For example, a target device activity item may be indicative of a mobility rate associated with the target device (e.g., 1 mile per hour). In this regard, for example, a mobility rate may be an indicative of how far the target device has moved in a defined time period. As another example, a target device activity item may be indicative of a static since time (e.g., 9:00). In this regard, for example, a static since time may be indicative of an amount of time since the target device has moved. As another example, a target device activity item may be indicative of a last known position (e.g., a latitude and longitude). In this regard, for example, a last known position may be indicative of a last known position of the target device. As another example, a target device activity item may be indicative of a battery level (e.g., 22%). In this regard, for example, a battery level may be indicative of an amount of battery life that the target device has remaining. As another example, a target device activity item may be indicative of a signal strength (e.g., 2 out of 5).

In some embodiments, the search event operations apparatus (e.g., the mobile search event operations apparatus, the onboard search event operations apparatus, and/or the cloud-based search event operations apparatus) is configured to access target device activity data from the target device. In this regard, for example, the target device may include one or more sensors configured to capture and/or generate target device activity data. Additionally, or alternatively, the search event operations apparatus is configured to access target device activity data from a cellular network. For example, the search event operations apparatus may be configured to access target device activity data from a cellular tower in proximity to the target device. Additionally, or alternatively, the search event operations apparatus is configured to access target device activity data from a global positioning system (GPS) network. For example, the search event operations apparatus may be configured to access target device activity data from a satellite in proximity to the target device.

In some embodiments, the search event operations apparatus (e.g., the mobile search event operations apparatus, the onboard search event operations apparatus, and/or the cloud-based search event operations apparatus) is configured to generate a target device activity interface component, such as illustrated in FIG. 4. In some embodiments, the search event operations apparatus is configured to generate the target device activity interface component based on target device activity data. In this regard, for example, the target device activity interface component may include one or more target device activity items. For example, the target device activity interface component may include a mobility rate, a static since time, a last known position, a signal strength, and/or the like.

As shown in block 1206, the method 1200 may include generating a target device activity interface component. As described above, in some embodiments, the search event operations apparatus (e.g., the mobile search event operations apparatus, the onboard search event operations apparatus, and/or the cloud-based search event operations apparatus) is configured to access historical search event data. In some embodiments, historical search event data includes one or more items of data representative and/or indicative of one or more historical search events. For example, historical search event data may be indicative of one or more patterns flown by the aircraft and/or one or more other aircraft during a historical search event. As another example, historical search event data may be indicative of one or more landing zones used by the aircraft and/or one or more other aircraft during a historical search event. As another example, historical search event data may be indicative of one or more hover zones used by the aircraft and/or one or more other aircraft during a historical search event.

In some embodiments, the search event operations apparatus (e.g., the mobile search event operations apparatus, the onboard search event operations apparatus, and/or the cloud-based search event operations apparatus) is configured to access historical search event data from the target device. Additionally, or alternatively, the search event operations apparatus is configured to access historical search event data from one or more historical search event databases. For example, the search event operations apparatus may be configured to access historical search event data from a historical search event database associated with the search event operations apparatus.

In some embodiments, the search event operations apparatus (e.g., the mobile search event operations apparatus, the onboard search event operations apparatus, and/or the cloud-based search event operations apparatus) is configured to generate a historical search event interface component, such as illustrated in FIG. 6. In some embodiments, the search event operations apparatus is configured to generate the historical search event interface component based on historical search event data. In this regard, for example, the historical search event interface component may include one or more historical search event action items. For example, the historical search event interface component may include a historical search event action item that is associated with showing one or more historical flight patterns used by the aircraft. As another example, the historical search event interface component may include a historical search event action item that is associated with predicting a landing zone. As another example, the historical search event interface component may include a historical search event action item that is associated with predicting a landing zone. As another example, the historical search event interface component may include a historical search event action item that is associated with predicting a hover zone.

In some embodiments, the one or more historical search event action items are selectable. In this regard, for example, the one or more historical search event action items may be selectable to show a historical flight pattern used by the aircraft and/or one or more other aircraft (e.g., when searching for the target device a target, a historical target, and/or a historical target device). As another example, the one or more historical search event action items may be selectable to predict a landing zone (e.g., a landing zone near the target device and/or a target). In this regard, for example, predicting a landing zone may include the search event operations apparatus and/or the aircraft being configured to analyzing the terrain using historical search event data and/or a camera associated with the aircraft to identify whether a particular area is suitable for being used as a landing zone (e.g., is an area flat, level, of sufficient size, etc.) As another example, the one or more historical search event action items may be selectable to predict a hover zone (e.g., a hover zone near the target device and/or a target). In some embodiments, the search event operations apparatus and/or the aircraft is configured to predict a hover zone when the search event operations apparatus predicts that an area is not suitable for being used as a landing zone. In this regard, for example, predicting a hover zone may include the search event operations apparatus and/or the aircraft being configured to analyze terrain using historical search event data and/or a camera associated with the aircraft and determine that a particular area is not suitable for being used as a landing zone (e.g., is an area flat, level, of sufficient size, etc.). Said differently, for example, when there is not a suitable landing zone the search event operations apparatus may be configured to cause the aircraft to hover.

As shown in block 1208, the method 1200 may include generating a search zone interface component. As described above, in some embodiments, the search zone interface component is generated using real-time target physical condition data, search event data, static target physical condition data, target device activity data, target proximity data, and/or historical search event data.

In some embodiments, the search zone interface component includes a vertical view sub-interface component. In some embodiments, the vertical view sub-interface component is configured to provide a top-down view of an area associated with a search event. In some embodiments, the vertical view sub-interface component includes a representation of a cellular tower. In some embodiments, the vertical view sub-interface component includes a representation of the target device and/or a target associated with the target device. In some embodiments, the vertical view sub-interface component includes a representation of the aircraft. In some embodiments, the vertical view sub-interface component includes a representation of one or more unsafe landing zones (e.g., based on terrain conditions). In some embodiments, the vertical view sub-interface component includes a representation of one or more search area (e.g., a line, box, etc. that delineates a search area).

In some embodiments, the search zone interface component includes a horizontal view sub-interface component. In some embodiments, the horizontal view sub-interface component is configured to provide a side view of an area associated with a search event. In some embodiments, the horizontal view sub-interface component includes a representation of the aircraft. In some embodiments, the horizontal view sub-interface component includes a representation of one or more unsafe landing zones (e.g., based on terrain conditions). In some embodiments, the horizontal view sub-interface component includes a representation of one or more search area (e.g., a line, box, etc. that delineates a search area).

As shown in block 1210, the method 1200 may include causing the search zone interface component to be rendered to a search zone interface. As described above, in some embodiments, causing the search zone interface component to be rendered to a search zone interface associated with the search event operations apparatus.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this specification contains many specific embodiment and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

1. A method comprising:
receiving search event data representative of a search event;
accessing real-time target physical condition data from a target device, wherein the real-time target physical condition data is representative of one or more real-time target physical condition items;
generating a target physical condition interface component based on the real-time target physical condition data, wherein the target physical condition interface component comprises the one or more real-time target physical condition items;
generating a search event access interface component, wherein the search event access interface component comprises one or more access links; and
causing the target physical condition interface component to be rendered to a search event operations interface in response to a selection of a target physical condition access link of the one or more access links.

2. The method of claim 1, wherein the target device comprises a wearable device.

3. The method of claim 1, further comprising:
initiating performance of one or more search event responsive actions.

4. The method of claim 3, wherein initiating performance of one or more search event responsive actions comprises transmitting an action message to the target device.

5. The method of claim 3, wherein initiating performance of one or more search event responsive actions comprises transmitting an instruction message to an enterprise device.

6. The method of claim 3, wherein initiating performance of one or more search event responsive actions comprises:
detecting one or more secondary devices in proximity to the target device; and
transmitting an alert message to the one or more secondary devices.

7. The method of claim 3, wherein initiating performance of one or more search event responsive actions comprises:
detecting a cellular tower in proximity to the target device; and
causing an aircraft to navigate towards the cellular tower in response to detecting the cellular tower in proximity to the target device.

8. The method of claim 1, further comprising:
generating a target proximity interface component, wherein the target proximity interface component comprises one or more target proximity action items.

9. The method of claim 1, further comprising:
generating a historical search event interface component, wherein the historical search event interface component comprises one or more historical search event action items.

10. The method of claim 1, further comprising:
generating a target device activity interface component, wherein the target device activity interface component comprises one or more target device activity items.

11. The method of claim 1, further comprising:
generating a search zone interface component, wherein the search zone interface component comprises a horizontal view sub-interface component and a vertical view sub-interface component; and
causing the search zone interface component to be rendered to a search zone interface.

12. The method of claim 1, further comprising:
accessing static target physical condition data representative of one or more static target physical condition items, wherein the target physical condition interface component further comprises the one or more static target physical condition items.

13. The method of claim 1, wherein the real-time target physical condition data is accessed from the target device in response to receiving the search event data.

14. An apparatus comprising memory and one or more processors communicatively coupled to the memory, the one or more processors configured to:
receive search event data representative of a search event;
access real-time target physical condition data from a target device, wherein the real-time target physical condition data is representative of one or more real-time target physical condition items;
generate a target physical condition interface component based on the real-time target physical condition data, wherein the target physical condition interface component comprises the one or more real-time target physical condition items;
generate a search event access interface component, wherein the search event access interface component comprises one or more access links; and
cause the target physical condition interface component to be rendered to a search event operations interface in response to a selection of a target physical condition access link of the one or more access links.

15. The apparatus of claim 14, wherein the one or more processors are further configured to:
initiate performance of one or more search event responsive actions.

16. The apparatus of claim 15, wherein initiating performance of one or more search event responsive actions comprises the one or more processors being further configured to transmit an action message to the target device.

17. The apparatus of claim 15, wherein initiating performance of one or more search event responsive actions comprises the one or more processors being further configured to transmit an instruction message to an enterprise device.

18. The apparatus of claim 15, wherein initiating performance of one or more search event responsive actions comprises the one or more processors being further configured to:
detect one or more secondary devices in proximity to the target device; and
transmit an alert message to the one or more secondary devices.

19. The apparatus of claim 15, wherein initiating performance of one or more search event responsive actions comprises the one or more processors being further configured to:
detect a cellular tower in proximity to the target device; and
cause an aircraft to navigate towards the cellular tower in response to detecting the cellular tower in proximity to the target device.

20. A computer program product comprising at least one non-transitory computer-readable storage medium having computer program code stored thereon that, in execution with at least one processor, configures the computer program product for:
receiving search event data representative of a search event;
accessing real-time target physical condition data from a target device, wherein the real-time target physical condition data is representative of one or more real-time target physical condition items;
generating a target physical condition interface component based on the real-time target physical condition data, wherein the target physical condition interface component comprises the one or more real-time target physical condition items;
generating a search event access interface component, wherein the search event access interface component comprises one or more access links; and
causing the target physical condition interface component to be rendered to a search event operations interface in response to a selection of a target physical condition access link of the one or more access links.
